(19) United States
(12) Patent Application Publication
(10) Pub. No.: US 2010/0297545 A1
(43) Pub. Date: Nov. 25, 2010

(54) Preparation Method of Composite Silica Nanoparticles with Monodispersity

(75) Inventors: Young Cheol Yoo, Ansan (KR); Jong Gil Shim, Ansan (KR); Byeong Ok Jo, Ansan (KR); O Sung Kwon, Ansan (KR)

Correspondence Address: BISHOP & DIEHL, LTD., 1320 TOWER ROAD, SCHAUMBURG, IL, 60173, US

(73) Assignee: Sukgyung AT Co., Ltd., Ansan (KR)

(21) Appl. No.: 12/767,011

(22) Filed: Apr. 26, 2010

(30) Foreign Application Priority Data
May 25, 2009 (KR) 10200945486

(51) Int. Cl. G03G 9/08; C09C 1/28

(52) U.S. Cl. 430/108.3; 106/446; 106/483; 977/773

(57) ABSTRACT

The present invention provides a preparation method of composite silica microparticles with monodispersity, comprising the steps of: (a) adding at least one precursor selected from a titania precursor and an alumina precursor, and a silica precursor to a solvent, which are hydrolyzed to form composite silica microparticles; (b) drying and calcining the composite silica microparticles; and (c) hydrophobically treating the calcined composite silica microparticles.

### CROSS-REFERENCE TO RELATED APPLICATIONS

This application claims priority to Korean application number 10-2009-45486, filed on May 25, 2009, which is incorporated herein by reference.

### TECHNICAL FIELD

The present invention relates to a preparation method of composite silica nanoparticles with monodispersity, and in particular, it relates to a preparation method of composite silica nanoparticles with monodispersity in which there is no aggregation between particles.

### BACKGROUND ART

Dry developers used in electronic photography and the like may be classified into 1-component developers which use toner in which colorant is dispersed in terminal resin by itself, and 2-component developers in which a carrier is combined with such toner.

When copying is performed using such developers, in order to have process suitability, a developer must have excellent fluidity, anti-caking property, fixedness, electrification property, cleaning property, etc. In order to increase the fluidity, anti-caking property, fixedness, cleaning property, etc., inorganic particles have been added to toner.

In general, the representative external additives that are added to the toner surface include inorganic particles such as silica (SiO₂), alumina (Al₂O₃), and titania (TiO₂), fluororesin particles such as vinylidene fluoride and polytetrafluoroethylene (PTFE), acryls manufactured by emulsion polymerization, and styrene-acrylate resin particles.

In general, inorganic particles such as silica are approximately 7 to 50 nm, and are added to toner in order to impart fluidity as granules. Of course, although those toners to which external additives having small particle diameters are added have good fluidity, if the particle diameter of silica is too small, then there are occurrences in which silica is buried at the toner surface due to stress applied to toner, and consequently there are occurrences in which the fluidity decreases as time passes whereby the size of external additives has profound effect on the print quality (PQ). Moreover, since such inorganic particles are present at the outermost surface of toner, the electrification property of toner is greatly affected, and as such, there is a need for development of inorganic particles having uniform size while having the particle diameter not being too small.

Moreover, when inorganic particles such as the conventional silica and alumina are used as external additives for toners, the problem of aggregation between particles due to the accessory electrification property and electrification homogeneity of each particle has reached a critical level.

Accordingly, in order to obtain a high-definition image by maintaining charge and charge distribution of toner and to enable uniform coating, there is a dire need for development of nanoparticles with monodispersity which have uniform particle size and in which there is no aggregation between particles.

### Problem to be Solved

The present invention has been devised to solve the problems inherent in the conventional technology as discussed above, and its object is to provide a preparation method of composite silica nanoparticles with monodispersity which have uniform particle size and in which there is no aggregation between particles.

### Means for Solving the Problem

The technical problem of the present invention as described above is achieved by the following means.

A preparation method of composite silica nanoparticles with monodispersity, comprising the steps of:

(1) (a) adding at least one precursor selected from a titania precursor and an alumina precursor, and a silica precursor to a solvent, which are hydrolyzed to form composite silica nanoparticles; (b) drying and calcining the composite silica nanoparticles; and (c) hydrophobically treating the calcined composite silica nanoparticles.

(2) A preparation method of composite silica nanoparticles with monodispersity according to Claim 1, further comprising the step of adding a basic catalyst to the solvent.

(3) A preparation method of composite silica nanoparticles with monodispersity according to Claim 1, characterized in that said silica precursor is silicon alkoxide.

(4) A preparation method of composite silica nanoparticles with monodispersity according to Claim 1, characterized in that said titania precursor or alumina precursor is a salt or an alkoxide of titanium or aluminum.

(5) A preparation method of composite silica nanoparticles with monodispersity according to Claim 1, characterized in that the average particle diameter of composite silica nanoparticles is from 10 to 500 nm.

(6) A preparation method of composite silica nanoparticles with monodispersity according to Claim 1, characterized in that the contact angle of composite silica microparticles with respect to water is from 100 to 170°.

(7) A preparation method of composite silica nanoparticles with monodispersity according to Claim 1, characterized in that the specific surface area of composite silica microparticles is from 5 to 200 m²/g.

### [Effect]

According to the present invention, it is possible to prepare a high level of hydrophobically treated composite silica nanoparticles having uniform particle size and which is capable of being prepared as particles with monodispersity without aggregation between particles. When one uses an external additive for a developing toner which is obtained from composite silica nanoparticles obtained according to the present invention, it is possible to obtain a high-definition image by maintaining charge and charge distribution of toner and to enable uniform coating.

### BRIEF DESCRIPTION OF THE DRAWINGS

FIG. 1 is a scanning electron microscope (SEM) photograph of composite silica nanoparticles obtained from Example 1 of the present invention.

FIG. 2 is a scanning electron microscope (SEM) photograph of composite silica nanoparticles obtained from Example 2 of the present invention.

FIG. 3 is a scanning electron microscope (SEM) photograph of composite silica nanoparticles obtained from Example 3 of the present invention.

FIG. 4 is a scanning electron microscope (SEM) photograph of composite silica nanoparticles obtained from Example 4 of the present invention.

FIG. 5 is a scanning electron microscope (SEM) photograph of composite silica nanoparticles obtained from Example 5 of the present invention.

### DETAILED DESCRIPTION OF THE INVENTION

Hereinbelow, the content of the present invention is described in greater detail.

The present invention provides a preparation method of composite silica nanoparticles with monodispersity, comprising the steps of: (a) adding at least one precursor selected from a titania precursor and an alumina precursor, and a silica precursor to a solvent, which are hydrolyzed to form composite silica nanoparticles; (b) drying and calcining the composite silica nanoparticles; and (c) hydrophobically treating the calcined composite silica nanoparticles.

In the present invention, a titania precursor or an alumina precursor is a titanium salt or an aluminum salt, or a titanium alkoxide or an aluminum alkoxide.

Examples of a titanium salt include titanium oxychloride, titanium chloride, titanium nitrate, titanium sulfate, etc., and examples of a titanium alkoxide include tinanium methoxide, titanium ethoxide, titanium propoxide, titanium isopropoxide, titanium butoxide, titanium 2-ethylhexoside, titanium tetraisopropoxide, etc.

Examples of an aluminum salt include aluminum chloride, sodium aluminate, aluminum nitrate, aluminum sulfate, aluminum alum, etc., and examples of an aluminum alkoxide include aluminum methoxide, aluminum ethoxide, aluminum isopropoxide, aluminum secondary butoxide, etc.

In the present invention, examples of a silica precursor include silicon alkoxides, such as tetramethyl orthosilicate (TMOS), tetraethyl orthosilicate (TEOS), 3-mercaptopropyl trimethoxysilane (MPTMS), phenyltrimethoxysilane (PTMS), vinyltrimethoxysilane (VTMS), methyltrimethoxysilane (MTMS), 3-aminopropyl trimethoxysilane (APTMS), 3-glycidoxypropyl trimethoxysilane (GPTMS), (3-trimethoxysilyl)propyl trimethoxysilane (TMSPMA), 3-mercaptopropyl trimethoxysilane (MPTMS), 3-(trimethoxysilyl)propyl isocyanate (TMSPI), etc. According to the structure and the particle size of the silica nanoparticles, the mixture ratio of two or more of the silicon alkoxides can be appropriately selected.

The silica precursors, titania precursors and/or aluminum precursors are mixed with an appropriate solvent, and an example of such a solvent may be water, alcohol, or a mixture thereof. For alcohol, a solvent such as methyl alcohol, ethyl alcohol, propyl alcohol, isopropyl alcohol, or butyl alcohol may be used singly or as a mixture, and among these, it is preferable to use ethyl alcohol, propyl alcohol, or isopropyl alcohol.

A clear composite silica precursor solution can be obtained by mixing the silica precursors, titania precursors and/or aluminum precursors in a solvent, and at this point, a catalyst may be added for stabilization of alkoxides. Examples of such a catalyst include amino alcohols such as 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, diethylmonoethanolamine, etc.

In the process for the preparation of a composite silica precursor solution of the step (a), it is preferable that the mixture ratio of titanium precursor and/or aluminum precursor is established with from 0.5 to 30 parts by weight of titania and/or alumina with respect to 100 parts by weight of silica. If the content of titania and/or alumina is less than 0.5 parts by weight, then there is a concern that it would be difficult to expect an effect due to the addition of such components, and if it exceeds 30 parts by weight, then there is a concern that it would be difficult to form composites and spheres.

The reaction temperature for the step (a) is preferably approximately 20-50° C., and if it is maintained below 20° C., then there is a concern that the degree of globulization would be low and that particles would not be uniform, and if it exceeds 50° C., then there is a concern that particle growth would be difficult whereby particles would be excessively miniaturized.

If an alkoxide stabilization catalyst is added in the reaction, then it is preferably added from 0.01 to 20 parts by weight in its content with respect to 100 parts by weight of the entire reaction solvent. If the content of the catalyst is less than 0.01 parts by weight, then it is difficult to expect stabilization of an alkoxide, and if it exceeds 20 parts by weight, then there is a concern that it would lead to yield decrease or particle non-uniformity or that the degree of globulization would decrease.

For the formation of composite silica nanoparticles, the reaction may be carried out by adding a basic catalyst to the reaction solution. A basic catalyst facilitates formation of composites by controlling the rate of hydrolysis of each component at the time of hydrolysis of two or three species of alkoxides or salts. However, even though an acid catalyst (c-HNO₃, HCl, CH₃COOH) can also be used in the reaction process of the present invention (in such case, the (clear) reaction is carried out after carrying out hydrolysis with an acid catalyst), the degree of globulization and uniformity of particles obtained from the subsequent secondary hydrolysis process decreases, and as such, a basic catalyst is preferable.

As such, it is preferable to adjust the pH of the solution within the range of from 7 to 10 through the addition of a base. If the pH of the solution is lower than 7, then there is a concern that a basic catalyst would be insufficient which would result in partial hydrolysis whereby the yield would decrease, and if it is higher than 10, in the case of alumina which is an amphiprotic compound, it would result in re-solubilization thereby making composite formation difficult, and in the case of titania, there is a concern that titania or silica would exist in glass state instead of as a constituent element of composites.

Examples of a basic catalyst to be used in the reaction are compounds containing an amine group and a hydroxyl group or an aqueous solution thereof, and representative examples of materials containing an amine group and k hydroxyl group include ammonia, sodium hydroxide, alkyl amine, or a mixture thereof.

Further, in the step (b) of the present invention, which is a step for calcining the composite silica nanoparticles containing the alumina and/or titania obtained from the step (a), it is preferable to pre-dry at 50 to 70° C. for 1 to 3 hours, which is followed by drying at 110 to 130° C. for 4 to 12 hours, which is followed by calcination. Such a calcination step is a step for carrying out the reaction so that the composite silica nanoparticles will have a crystal phase, and as such, it is preferable to carry out calcinations at 1000 to 1250° C. for 1 to 6 hours.

In the step (c) of the present invention, the composite silica nanoparticles containing the alumina and/or titania obtained from the step (b) is hydrophobically treated, whereby the composite silica nanoparticles containing the alumina and/or titania whose final surface is hydrophobically treated is prepared.

A hydrophobic agent is used for the hydrophobic treatment, and hydrophobic agents used in the present invention may include silane coupling agents such as hexamethyldisilanzane (HMDS), methyltrimethoxysilane (MTMS), dimethyldiethoxysilane (DMDES), trimethylethoxysilane (TMES), r-MPS, TEOS, etc., and titanium coupling agents such as isopropyl triisostearoyl titanate (KR-TTS), isopropyl dimethacryl isostearoyl titanate (KR-7), isopropyl tri(dodecyl)benzenesulfonyl titanate (KR-9S), isopropyl tri(dioctyl)pyrophosphato titanate (KR-38S), di(cumyl)phenyl oxoethylene titanate (KR-134S), di(dioctyl)pyrophosphate oxoethylene titanate (KR-138S), neopentyl(diallyl)oxy, tri(dioctyl)pyro-phosphato titanate (LICA-38), etc.

The hydrophobic agent may be used in the amount of from 1 to 20 parts by weight with respect to 100 parts by weight of the composite silica nanoparticles containing alumina and/or titania (compared with solid content).

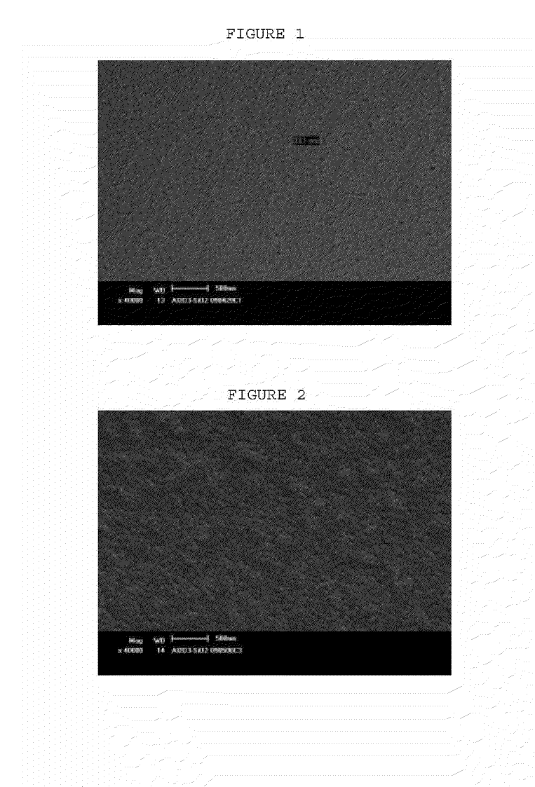

The composite silica nanoparticles containing alumina and/or titania prepared according to the present invention as described herein have spherical configuration with monodispersity having substantially identical size, and by coating the surface of such spherical particles with monodispersity with a hydrophobic material, they can be usefully employed as an external additive for toner. FIG. 1 shows a schematic diagram of the composite silica nanoparticles according to one example of the present invention.

The thus prepared composite silica nanoparticles of the present invention have the average particle diameter of from 30 to 200 nm, and it is preferable that they have a spherical configuration wherein the center values of particles are 30 nm, 50 nm, 100 nm, 150 nm and 200 nm. What it means by spherical configuration as referred to herein includes not only perfect spherical configuration, but also slightly crooked spherical configuration in which the size of an ordinary sphere is within the range of 0.6-1. Moreover, what is meant by the size of a sphere is the apparent/actual particle surface area of a sphere having the same volume as the actual particles.

Moreover, the composite silica nanoparticles containing alumina and/or titania according to the present invention preferably has the contact angle with respect to water of from 100 to 170°, and the specific surface area of from 20 to 100 m²/g. If the contact angle with respect to water of the composite silica nanoparticles containing alumina and/or titania is less than 100°, then the hydrophobicity decreases, and as such, there is a concern that, when they are used as an external additive for a toner, the printability of toner would decrease due to adsorption of moisture in the atmosphere, as well as the aggregation problem, and if it exceeds 170°, then it will be outside the measurement range due to measurement limitations, and it would be difficult to expect improved effect with the excess, and therefore, it is preferably implemented within the above-described range.

In addition, if the specific surface area of the composite silica nanoparticles is less than 5 m²/g, then it will be difficult to effectuate uniformity during coating with an external additive of toner due to aggregation of particles, and if it exceeds 100 m²/g, then the size of particles will be too small thereby making hydrophobic coating difficult, and there is a concern that partial printing during printing would be difficult.

The composite silica nanoparticles containing alumina and/or titania according to the present invention as described herein are used as an external additive for an electrostatic latent image developing toner. Such an external additive for a toner may be used singly or in combination with 2 or more species. Here, the term toner refers collectively to a color toner and a black/white toner.

If the composite silica nanoparticles containing alumina and/or titania are used as an external additive for a toner, then its mixing ratio is preferably from 0.01 to 20 parts by weight with respect to 100 parts by weight of toner particles, and it is more preferably from 0.1 to 5 parts by weight. If its mixing ratio is within such range, then there is sufficient adhesion to toner particles, and it is possible not only to obtain good fluidity, but it is also good for improving the electrification property of toner particles.

The composite silica nanoparticles containing alumina and/or titania can simply be mechanically attached to the surface of toner particles, and it is satisfactory if they are loosely fixed at the surface. Moreover, they may cover the entire surface of toner particles, and they may cover a part thereof.

Although the electrostatic latent image developing toner using the composite silica nanoparticles containing alumina and/or titania as an external additive for a toner as described herein can be used as a single-component developing agent, it can be used as a two-component developing agent by mixing with a carrier. If it is used as a two-component developing agent, then an external additive for a toner is not added to toner particles beforehand, and it is preferable to add it at the time of mixing toner particles and carrier, and carry out surface coating of toner particles. At this time, iron powder and other materials known in the prior art may be used as a carrier.

Hereinbelow, preferred examples are provided to aid understanding of the present invention, however, the below examples are only intended to illustrate the present invention, and it is not intended that the scope of the present invention be limited to the below examples.

### Example A

### Preparation of Alumina-Silica Composite Nanoparticles of Positive Charge

### Example 1

### Preparation of 2.5 Weight % Alumina-Silica Composite Silica Nanoparticles Having the Average Particle Diameter of 30 nm

120 ml of water, 250 ml of ethyl alcohol, and 8 ml of ammonia water were added to a 500-ml flask and were heated while the clear mixture solution was being stirred until the temperature was raised to 45° C. After 22 g of tetraethyl orthosilicate (TEOS), 1 g of aluminum sec-butoxide [Al (OBu)₃], and 4 g of diethanolamine were uniformly mixed in another 100-ml beaker for 30 minutes, they were added altogether to the aforementioned solution and condensation polymerization reaction of the hydrolysates was carried out for 4 hours. During the alumina-silica mixture solution reaction, the temperature was maintained at 45° C. Products which resulted from this were filtered and dried, whereby white alumina-silica composite dry matter was obtained. The dry matter was heat treated at 800° C. for 2 hours, whereby alumina-silica composite nanoparticles were obtained. 15 parts by weight of hexamethyldisilazane (HMDS) were added to the thus obtained alumina-silica nanoparticles (compared with solid content), and this was hydrophobically treated by refluxing, whereby the intended alumina-silica composite nanoparticles were obtained.

As a result of analyzing the thus obtained alumina-silica composite nanoparticles with SEM (Shimadsu Corporation, SS-550), they were confirmed to be spherical particles of 30 nm (FIG. 1), as a result of analyzing with BET (Micrometrics Corporation, TRISTAR 3000), it was confirmed to be 65 m²/g, and as a result of measuring the contact angle with Contact Angle Analyzer (SEQ Corporation, PHOENIX 300), it was confirmed to be 157°.

### Example 2

### Preparation of 2.5 Weight % Alumina-Silica Composite Silica Nanoparticles Having the Average Particle Diameter of 50 nm

120 ml of water, 250 ml of ethyl alcohol, and 8 ml of ammonia water were added to a 500-ml flask and were heated while the clear mixture solution was being stirred until the temperature was raised to 40° C. After 22 g of tetraethyl orthosilicate (TEOS), 1 g of aluminum sec-butoxide [Al(OBu)₃], and 4 g of diethanolamine were uniformly mixed in another 100-ml beaker for 30 minutes, they were added altogether to the aforementioned solution and condensation polymerization reaction of the hydrolysates was carried out for 4 hours. During the alumina-silica mixture solution reaction, the temperature was maintained at 40° C. Products which resulted from this were filtered and dried, whereby white alumina-silica composite dry matter was obtained. The dry matter was heat treated at 800° C. for 2 hours, whereby alumina-silica composite nanoparticles were obtained. 12 parts by weight of hexamethyldisilazane (HMDS) were added to the thus obtained alumina-silica nanoparticles (compared with solid content), and this was hydrophobically treated by refluxing, whereby the intended alumina-silica composite nanoparticles were obtained.

As a result of analyzing the thus obtained alumina-silica composite nanoparticles with SEM (Shimadsu Corporation, SS-550), they were confirmed to be spherical particles of 50 nm (FIG. 2), as a result of analyzing with BET (Micrometrics Corporation, TRISTAR 3000), it was confirmed to be 49 m²/g, and as a result of measuring the contact angle with Contact Angle Analyzer (SEQ Corporation, PHOENIX 300), it was confirmed to be 159°.

### Example 3

### Preparation of 2.5 Weight % Alumina-Silica Composite Silica Nanoparticles Having the Average Particle Diameter of 100 nm

120 ml of water, 250 ml of ethyl alcohol, and 10 ml of ammonia water were added to a 500-ml flask and were heated while the clear mixture solution was being stirred until the temperature was raised to 40° C. After 22 g of tetraethyl orthosilicate (TEOS), 1 g of aluminum sec-butoxide [Al(OBu)₃], and 4 g of diethanolamine were uniformly mixed in another 100-ml beaker for 30 minutes, they were added altogether to the aforementioned solution and condensation polymerization reaction of the hydrolysates was carried out for 4 hours. During the alumina-silica mixture solution reaction, the temperature was maintained at 40° C. Products which resulted from this were filtered and dried, whereby white alumina-silica composite dry matter was obtained. The dry matter was heat treated at 800° C. for 2 hours, whereby alumina-silica composite nanoparticles were obtained. 10 parts by weight of hexamethyldisilazane (HMDS) were added to the thus obtained alumina-silica nanoparticles (compared with solid content), and this was hydrophobically treated by refluxing, whereby the intended alumina-silica composite nanoparticles were obtained.

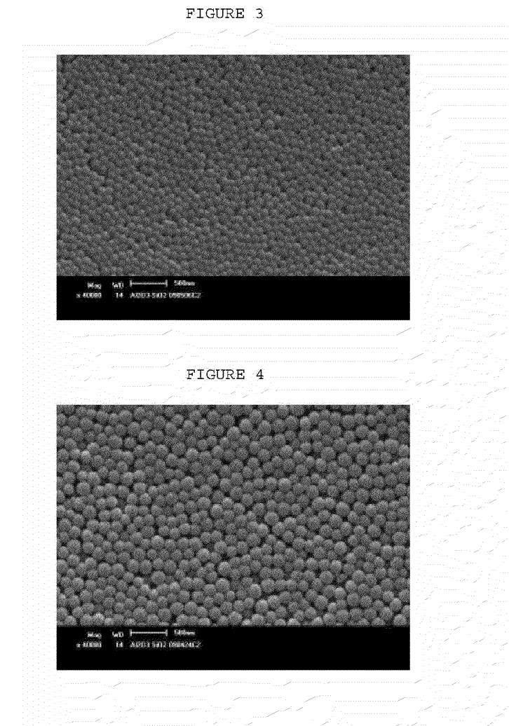

As a result of analyzing the thus obtained alumina-silica composite nanoparticles with SEM (Shimadsu Corporation, SS-550), they were confirmed to be spherical particles of 100 nm (FIG. 3), as a result of analyzing with BET (Micrometrics Corporation, TRISTAR 3000), it was confirmed to be 25 m²/g, and as a result of measuring the contact angle with Contact Angle Analyzer (SEQ Corporation, PHOENIX 300), it was confirmed to be 161°.

### Example 4

### Preparation of 2.5 Weight % Alumina-Silica Composite Silica Nanoparticles Having the Average Particle Diameter of 150 nm

120 ml of water, 250 ml of ethyl alcohol, and 10 ml of ammonia water were added to a 500-ml flask and were heated while the clear mixture solution was being stirred until the temperature was raised to 37° C. After 22 g of tetraethyl orthosilicate (TEOS), 1 g of aluminum sec-butoxide [Al(OBu)₃], and 4 g of diethanolamine were uniformly mixed in another 100-ml beaker for 30 minutes, they were added altogether to the aforementioned solution and condensation polymerization reaction of the hydrolysates was carried out for 4 hours. During the alumina-silica mixture solution reaction, the temperature was maintained at 37° C. Products which resulted from this were filtered and dried, whereby white alumina-silica composite dry matter was obtained. The dry matter was heat treated at 800° C. for 2 hours, whereby alumina-silica composite nanoparticles were obtained. 8 parts by weight of hexamethyldisilazane (HMDS) were added to the thus obtained alumina-silica nanoparticles (compared with solid content), and this was hydrophobically treated by refluxing, whereby the intended alumina-silica composite nanoparticles were obtained.

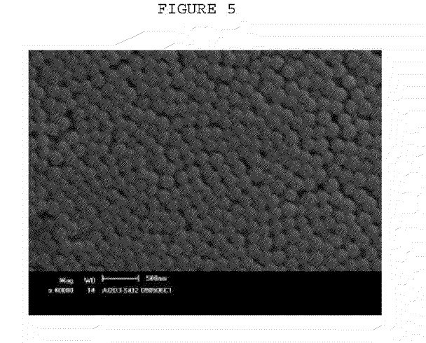

As a result of analyzing the thus obtained alumina-silica composite nanoparticles with SEM (Shimadsu Corporation, SS-550), they were confirmed to be spherical particles of 150 nm (FIG. 4), as a result of analyzing with BET (Micrometrics Corporation, TRISTAR 3000), it was confirmed to be 21 m²/g, and as a result of measuring the contact angle with Contact Angle Analyzer (SEQ Corporation, PHOENIX 300), it was confirmed to be 153°.

### Example 5

### Preparation of 2.5 Weight % Alumina-Silica Composite Silica Nanoparticles Having the Average Particle Diameter of 200 nm

120 ml of water, 250 ml of ethyl alcohol, and 10 ml of ammonia water were added to a 500-ml flask and were heated while the clear mixture solution was being stirred until the temperature was raised to 30° C. After 22 g of tetraethyl orthosilicate (TEOS), 1 g of aluminum sec-butoxide [Al (OBu)₃], and 4 g of diethanolamine were uniformly mixed in another 100-ml beaker for 30 minutes, they were added altogether to the aforementioned solution and condensation polymerization reaction of the hydrolysates was carried out for 4 hours. During the alumina-silica mixture solution reaction, the temperature was maintained at 30° C. Products which resulted from this were filtered and dried, whereby white alumina-silica composite dry matter was obtained. The dry matter was heat treated at 800° C. for 2 hours, whereby alumina-silica composite nanoparticles were obtained. 6 parts by weight of hexamethyldisilazane (HMDS) were added to the thus obtained alumina-silica nanoparticles (compared with solid content), and this was hydrophobically treated by refluxing, whereby the intended alumina-silica composite nanoparticles were obtained.

As a result of analyzing the thus obtained alumina-silica composite nanoparticles with SEM (Shimadsu Corporation, SS-550), they were confirmed to be spherical particles of 200 nm (FIG. 5), as a result of analyzing with BET (Micrometrics Corporation, TRISTAR 3000), it was confirmed to be 16 m²/g, and as a result of measuring the contact angle with Contact Angle Analyzer (SEQ Corporation, PHOENIX 300), it was confirmed to be 152°.

### Example B

### Preparation of Alumina-Silica Composite Nanoparticles of Negative Charge

### Examples 6 to 10

### Preparation of Alumina-Silica Composite Nanoparticles of Negative Charge

The intended alumina-silica composite nanoparticles were obtained by carrying out the same procedures as Examples 1 to 5 except for using dimethyldiethoxysilazane (DMDES) instead of hexamethyldisilazane (HMDS) for the hydrophobic treatment. Reaction temperature (° C.), hydrophobic treatment agent, and charge of the alumina-silica composite nanoparticles prepared in the Examples 1 to 5 are shown in the below Table 1.

TABLE 1

| | Reaction temperature | Hydrophobic treatment | |
|---|---|---|---|
| Classification | (° C.) | (parts by weight) | Charge |
| Example 1 | 45 | HMDS (15) | + |
| Example 2 | 40 | HMDS (12) | + |
| Example 3 | 40 | HMDS (10) | + |
| Example 4 | 37 | HMDS (8) | + |
| Example 5 | 30 | HMDS (6) | + |
| Example 6 | 45 | DMDES (15) | − |
| Example 7 | 40 | DMDES (12) | − |
| Example 8 | 40 | DMDES (10) | − |
| Example 9 | 37 | DMDES (8) | − |
| Example 10 | 30 | DMDES (6) | − |

In addition, average particle diameter, contact angle with respect to water, and specific surface area of the alumina-silica composite nanoparticles prepared in the Examples 1 to 10 are shown in the below Table 2.

TABLE 2

| | | | Specific |
|---|---|---|---|
| | Average particle | Contact angle with | surface area |
| Classification | diameter (nm) | respect to water (°) | (m²/g) |
| Example 1 | 30 | 157 | 65 |
| Example 2 | 50 | 159 | 49 |
| Example 3 | 100 | 161 | 25 |
| Example 4 | 150 | 153 | 21 |
| Example 5 | 200 | 152 | 16 |
| Example 6 | 30 | 150 | 63 |
| Example 7 | 50 | 152 | 50 |
| Example 8 | 100 | 154 | 23 |
| Example 9 | 150 | 156 | 20 |
| Example 10 | 200 | 147 | 17 |

### Examples 11 to 20

### Preparation of Toner Mixed with External Additive

After 96 parts by weight of a polyester resin having the glass transition temperature of 60° C. and the softening point of 100° C. and 4 parts by weight of a colorant (product name: Carmine 6BC, manufactured by Sumika Color Co., Ltd.) were kneaded and pulverized while being melted, they were apportioned and a toner having the average particle diameter of 7 μm was obtained. 0.3 g of the alumina-silica composite nanoparticles prepared in the Examples 1 to 10 were added to each 10 g of this toner, whereby a toner mixed with an external additive (Examples 11 to 20) was obtained.

In order to determine the performance of the developing agent of the present invention, measurement was taken with respect to toner usage with the method described below by using the developing agents prepared in the Examples 11 to 20, and the results thereof are shown in the below Table 3.

Initially, measurement of toner usage was taken through the steps of:

(a) measuring the weight of CPU (toner cartridge) prior to carrying out the experiment;

(b) printing 5,000 prints on letter/A4 size paper;

(c) measuring the weight of CPU subsequent to the completion of 5,000 prints; and

(d) obtaining the consumption per 5,000 prints and then obtaining the consumption of toner consumed per 1 sheet of print. For comparative examples, developing agents which were each prepared by the same method as Example 11 except that the alumina (or titania) nanoparticles of the present invention were not used (Comparative Examples 1 and 2), were used.

TABLE 3

| | 1-Component developing agent (+) | | | | | |
|---|---|---|---|---|---|---|
| | Example | Example | Example | Example | Example | Comparative |
| | 11 | 12 | 13 | 14 | 15 | example 1 |
| Toner usage | 19.8 | 18.6 | 16.7 | 16.9 | 18.7 | 22.9 |
| (mg/pg@78/80) | | | | | | |
| | 1-Component developing agent (−) | | | | | |
| | Example | Example | Example | Example | Example | Comparative |
| | 16 | 17 | 18 | 19 | 20 | example 2 |
| Toner usage | 20.4 | 19.1 | 18.4 | 18.6 | 18.8 | 23.8 |
| (mg/pg@78/80) | | | | | | |

Subsequent to using the developing agents of the Examples 11 to 20 of the present invention, clear high-definition image appeared throughout printing, and in particular, as shown in the above Table 3, it was possible to confirm that toner usage significantly decreased.

As described herein, although the present invention is described by referring to its preferred examples, it should be understood that any person of ordinary skill in the relevant art is able to modify and change the present invention in various ways within the scope which does not exceed the concept and limitations of the present invention as recited in the scope of patent claims as annexed below.

What is claimed is:

1. A preparation method of composite silica nanoparticles with monodispersity, comprising the steps of:
(a) adding at least one precursor selected from a titania precursor and an alumina precursor, and a silica precursor to a solvent, which are hydrolyzed to form composite silica nanoparticles;
(b) drying and calcining the composite silica nanoparticles; and
(c) hydrophobically treating the calcined composite silica nanoparticles.

2. The preparation method of claim 1, further comprising the step of adding a basic catalyst to the solvent.

3. The preparation method of claim 2, wherein the basic catalyst comprises amino alcohols or the like kind.

4. The preparation method of claim 1, wherein the solvent comprises water, alcohol, or a mixture thereof.

5. The preparation method of claim 1, wherein the step (a) further comprises mixing between 0.5 to 30 parts by weight of at least one of titanium or aluminum precursor with 100 parts by weight of silica.

6. The preparation method of claim 1, wherein the reaction temperature for the step (a) is approximately 20-50° C.

7. The preparation method of claim 1, wherein the step (a) further comprises adding an alkoxide stabilization catalyst, wherein 0.01 to 20 parts by weight of the catalyst is added per 100 parts by weight of the solvent.

8. The preparation method of claim 1, wherein the pH of the solution is 7-10.

9. The preparation method of claim 1, wherein the step (b) further comprises the step of pre-drying the composite obtained from the step (a) at 50 to 70° C. for 1 to 3 hours, which is followed by drying at 110 to 130° C. for 4 to 12 hours.

10. The preparation method of claim 1, wherein the calcinations step in the step (b) is at 1000 to 1250° C. for 1 to 6 hours.

11. The preparation method of claim 1, wherein said silica precursor is silicon alkoxide.

12. The preparation method of claim 1, wherein said titania precursor or alumina precursor is a salt or an alkoxide of titanium or aluminum.

13. The preparation method of claim 1, wherein the average particle diameter of composite silica nanoparticles is from 10 to 500 nm.

14. The preparation method of claim 1, wherein the contact angle of composite silica nanoparticles with respect to water is from 100 to 170°.

15. The preparation method of claim 1, wherein the specific surface area of composite silica nanoparticles is from 5 to 200 m²/g.

16. A composite of silica nanoparticles with monodispersity for use as an external additive for a toner, having a diameter of between 10 to 500 nm, a contact angle of between 100 to 170° with respect to water, and a specific surface area of between 5 to 200 m²/g.

17. The composite according to claim 16, further comprising a silica precursor and at least one precursor selected from a titania precursor and an alumina precursor.

18. The composite according to claim 16, wherein the nanoparticles are substantially spherical having substantially identical sizes.

19. The composite according to claim 18, wherein the nanoparticles have a spherical configuration with a diameter of between 30-200 nm.

20. The composite according to claim 16, wherein 0.01 to 20 parts by weight of the external additive is mixed with 100 parts by weight of toner particles.

21. The composite according to claim 16, wherein 0.1 to 5 parts by weight of the external additive is mixed with 100 parts by weight of toner particles.

22. The composite according to claim 16, wherein the external additive is hydrophobic.

23. The composite according to claim 16, wherein the external additive is used as a single-component developing agent or a two-component developing agent.
